(19) United States
(12) Patent Application Publication
(10) Pub. No.: US 2007/0024049 A1
(43) Pub. Date: Feb. 1, 2007

(54) Vehicle maintenance calendar

(75) Inventors: John F. Armstrong III, Spring, TX (US); George E. Goodwin, Spring, TX (US)

Correspondence Address: LAW FIRM OF INDRANIL CHOWHURY, P.C, 4800 SUGAR GROVE BLVD SUITE 290, STAFFORD, TX, 77477, US

(73) Assignee: D & P Holdings, Inc.

(21) Appl. No.: 11/152,911

(22) Filed: Jun. 15, 2005

(51) Int. Cl. B42D 5/04

(52) U.S. Cl. 283/2

(57) ABSTRACT

A vehicle maintenance calendar with a personalization portion and a scheduling portion wherein the scheduling portion has at least one recommended vehicle maintenance service printed on a particular date. The personalization portion and the scheduling portion may be secured together using sewing, staples, adhesives, tape, spiral bound, Velcro™, tacks, brads, prongs, glue, pins, paper clips, and so on. Printed on a page is the personalization portion that includes a photograph, the date of purchase of the vehicle, the type of vehicle purchased, the name of the seller/dealership of the vehicle, and contact information for the seller/dealership. The photograph shows the vehicle, an owner of the vehicle, and background environment that the owner is familiar with and finds pleasing. A customer inducement appendix is attached to the personalization portion in the calendar. The customer inducement appendix comprises a picture, wherein the picture includes a vehicle owner superimposed on a vehicle.

### FIELD OF THE INVENTION

This invention relates generally to a calendar for vehicle owners, more particularly, to a calendar with a personalization portion and a scheduling portion wherein the scheduling portion has at least one pre-printed recommended vehicle maintenance service on a particular date.

### BACKGROUND OF THE INVENTION

Automobiles, golf carts, motorcycles, scooters, go-karts, motorized pedal (MOPED) vehicles, bicycles, tricycles, quad cycles, boats, jet skis, wheelchairs, Segways™ and other types of vehicles that operate using mechanical devices require periodic service and maintenance. When the vehicle is first purchased by an individual, the dealer selling the vehicle may provide a service and maintenance manual, indicating the service and maintenance intervals needed to keep the vehicle in operating condition. In some manuals, service and maintenance intervals may be described as a number of months between required or recommend service and maintenance. In some other service and maintenance manuals, service and maintenance intervals may be described as a distance (in miles or kilometers) traveled by the vehicle between required or recommended service and maintenance.

Service and maintenance of the vehicle may be performed at the dealer who sold the vehicle or at an independent service shop. In the hopes that the owner will return to the dealer, many dealers may give to the owner laminated and colorful envelope holders containing pamphlets, business cards, coupons, and the service manual upon selling the vehicle to the owner. Printed on the envelope holder may be the dealer's contact information as well as a table summary of the required or recommended service and maintenance. However, the owner of the vehicle may place the envelope holder containing the service and maintenance manuals into the glove or storage compartment of the vehicle and forget that these important documents exist.

Thus, what is needed is an apparatus and method of reminding the owner of the vehicle of required or recommended service and maintenance that is attractive and regularly visible to the owner, and not easily misplaced or forgotten.

### SUMMARY OF THE INVENTION

The problems noted above are solved in large part by a calendar with a personalization portion and a scheduling portion wherein the scheduling portion has at least one recommended vehicle maintenance service printed on a particular date. The personalization portion and the scheduling portion are secured together using sewing, staples, adhesives, tape, spiral bound, Velcro™, tacks, brads, prongs, glue, pins, paper clips, and so on. Printed on a page is the personalization portion that includes a photograph, the date of purchase of the vehicle, the type of vehicle purchased, the name of the seller/dealership of the vehicle, and contact information for the seller/dealership. The photograph shows the vehicle, an owner of the vehicle, and background environment that the owner is familiar with and finds pleasing. A coupon appendix in the calendar is attached to the personalization portion. The coupon appendix contains one or more discount coupons for vehicle maintenance services and vehicle dealership contact information. A customer inducement appendix is attached to the personalization portion in the calendar. The customer inducement appendix comprises a picture, wherein the picture includes a vehicle owner includes a vehicle owner superimposed on a vehicle.

These and other features of the present invention will become readily apparent to those having ordinary skill in the art upon reading the following detailed description of the invention in view of the several drawings of the invention.

### BRIEF DESCRIPTION OF THE DRAWINGS

The nature and mode of operation of the embodiments of the invention will now be more fully described in the following detailed description of the invention taken with the accompanying drawing figures, in which:

FIG. 1 is a perspective view of a calendar in accordance with one embodiment of the invention;

FIG. 2 is an enlarged view in accordance with one embodiment of the invention for the personalization portion;

FIGS. 3A to 3E are enlarged views of the scheduling portion in accordance with some embodiments of the invention;

FIG. 4 is an enlarged views of an coupon appendix in accordance with one embodiment of the invention; and

FIG. 5 is an enlarged view of a customer inducement appendix in accordance with one embodiment of the invention.

### NOTATION AND NOMENCLATURE

Certain terms are used throughout the following description and claims to refer to particular parts of the calendar and their configuration. In the following discussion and in the claims, the terms “including” and “comprising” are used in an open-ended fashion, and thus should be interpreted to mean “including, but not limited to . . . ”. The term “attached” is intended to mean either an indirect or direct physical connection. Thus, if a first part attaches to a second part, that connection may be through a direct physical connection, or through an indirect physical connection via other parts and connections.

### DETAILED DESCRIPTION OF THE INVENTION

At the outset, it should be appreciated that like drawing numbers on different drawing views identify identical structural elements of the invention. While the present invention is described with respect to what are considered some embodiments, it is understood that the invention is not limited to the disclosed embodiments.

A vehicle maintenance calendar is described that in some embodiments of the invention may be hung on a wall. The calendar is customized to an owner of a vehicle and presented to the owner by the vehicle dealership when the owner picks up the vehicle at the dealership. The calendar has a picture of the owner, the vehicle, and messages congratulating the owner on their purchase of the vehicle. In accordance with some embodiments, the calendar may be a monthly calendar that has recommended maintenance and service requirements printed on particular dates of the calendar for the vehicle.

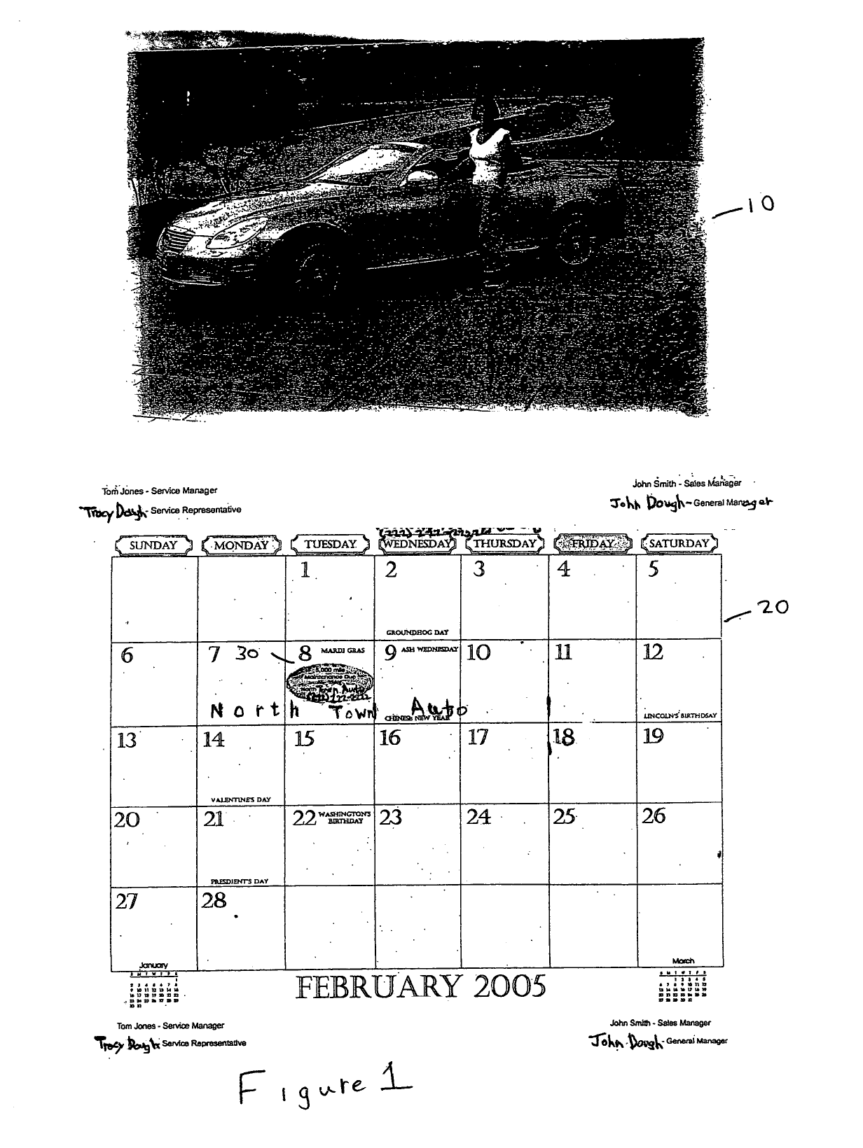

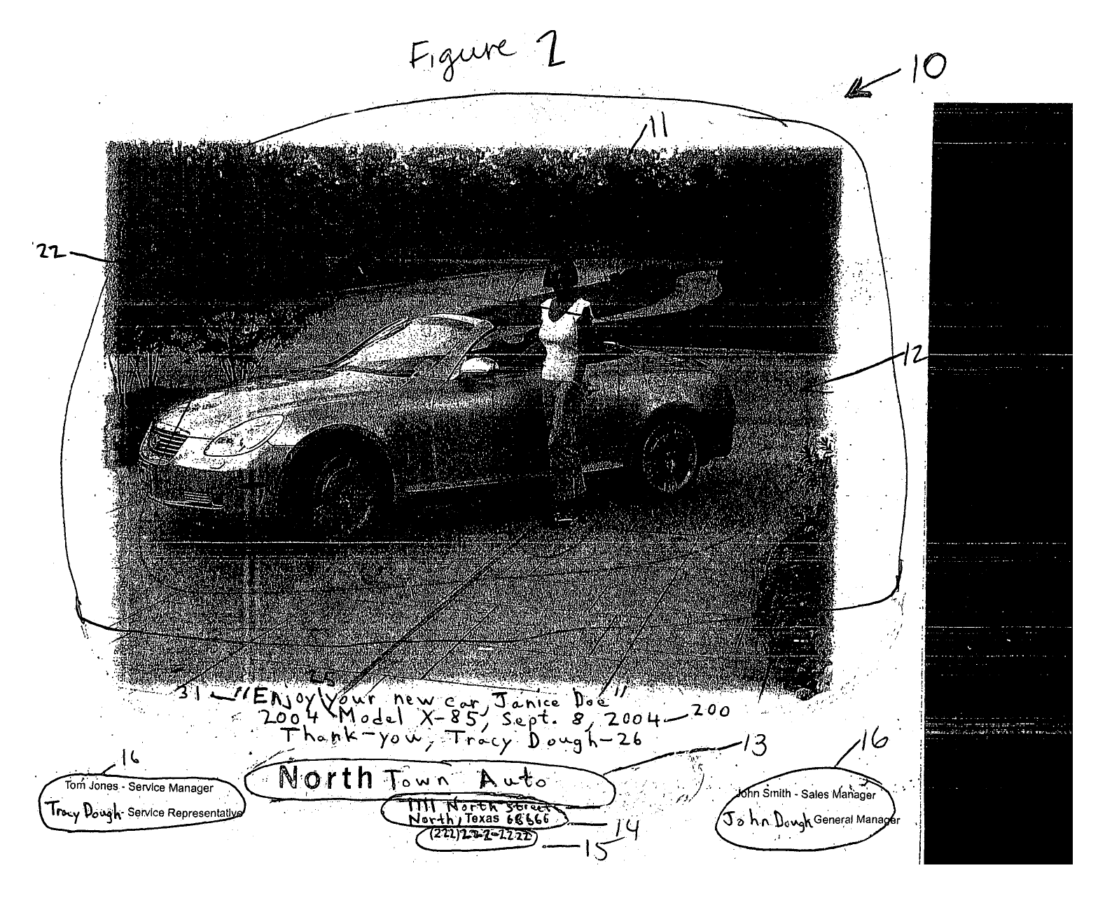

FIG. 1 is a perspective view of the vehicle maintenance calendar which shows calendar 1 with personalization portion 10 and scheduling portion 20 wherein the scheduling portion has at least one recommended vehicle maintenance service printed on a particular date 30 of Feb. 8, 2005. While the embodiments shown relate to automobiles, it is contemplated that that the embodiments of the present invention may be used for recommended maintenance on any vehicle known in the art. For example, while a vehicle may be generally thought of as an automobile, truck, golf cart, scooter, or motorcycle, the vehicle maintenance calendar may be used for any mobility assistance device, including but not limited to bicycles, boats, jet ski, go kart, wheelchairs, Segways™, and so on. Personalization portion 10 and scheduling portion 20 may be releasably attached together via any means known in the art, including, but not limited to, sewing, staples, adhesives, tape, spiral bound, Velcro™, tacks, brads, prongs, glue, pins, paper clips, and so on.

FIG. 2 is an enlarged view of various aspects of personalization portion 10 in accordance with the embodiment shown in FIG. 1, except viewed in greater detail. Personalization portion 10 may be personalized to display pictorial representations of a vehicle 12 and/or a vehicle owner 11 in an environment 22 that the new owner is familiar with and finds pleasing. The pictorial representation may be generated by superimposing the image of the owner 11 and vehicle 12 onto an image of the familiar environment 22. Digital manipulations of the owner, vehicle, and environment may be used to create a high quality picture that is visually pleasing to the owner.

Personalization portion 10, as shown in FIG. 2, may convey information about or to a vehicle owner such as date of vehicle purchase 200, type of vehicle purchased 25, name of vehicle seller 26, and other contact persons at the dealership 16. In addition, the personalization portion may convey information about the name of dealership 13, contact information for the dealership 14, phone number of dealership 15, and a personalized message to the new owner 31.

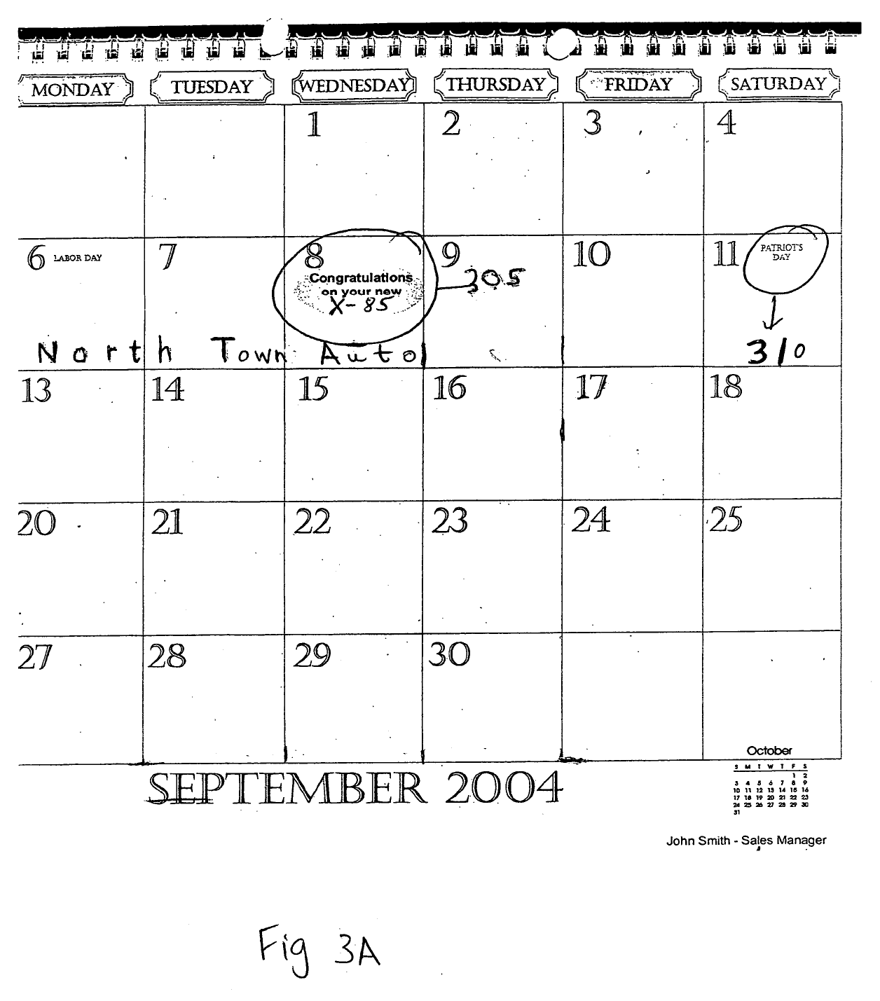

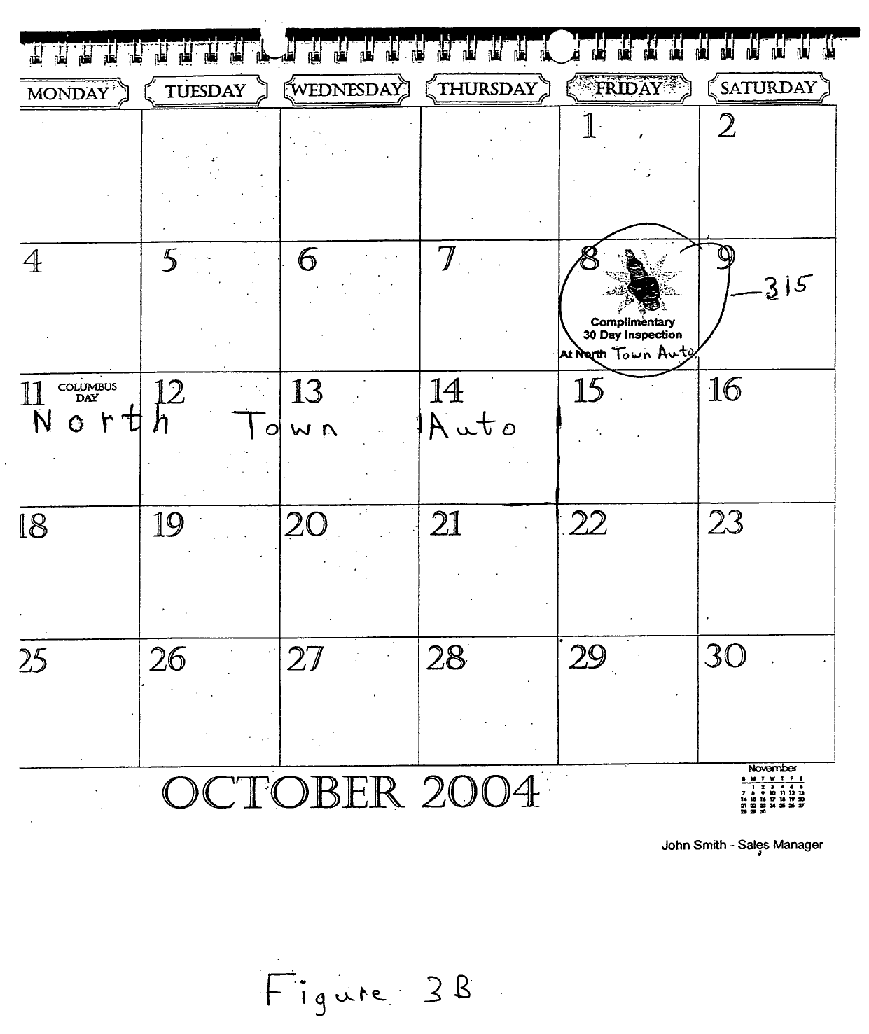

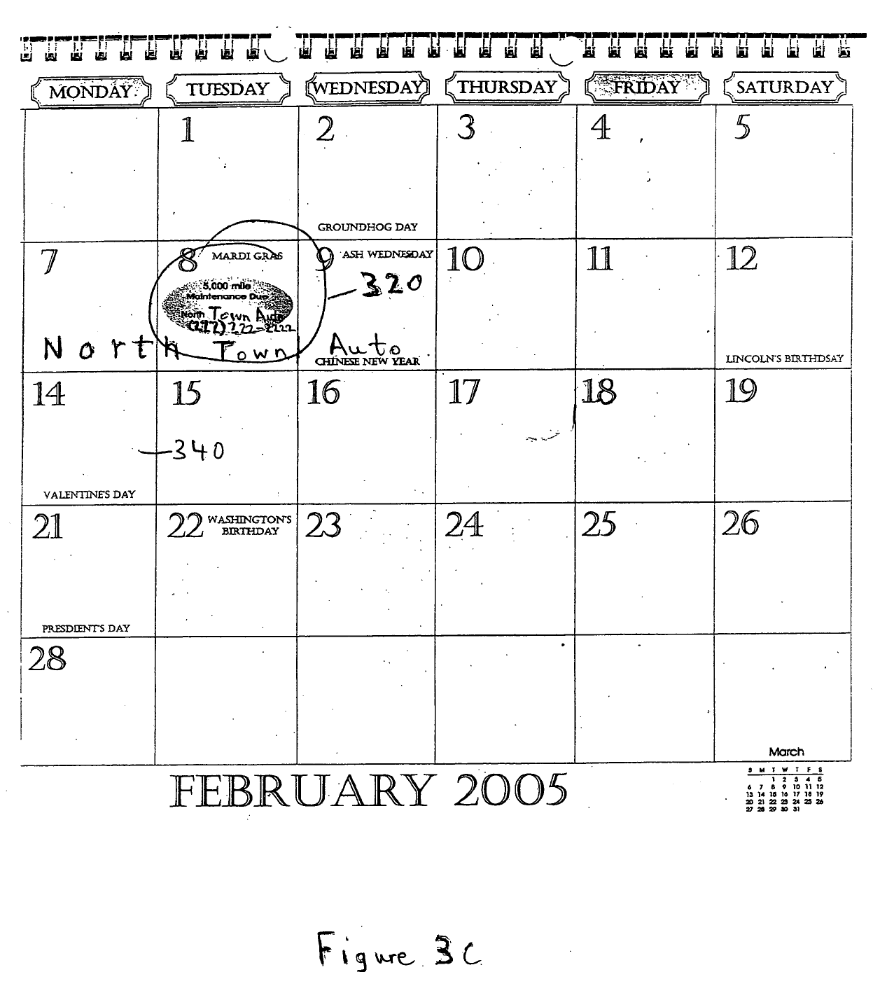

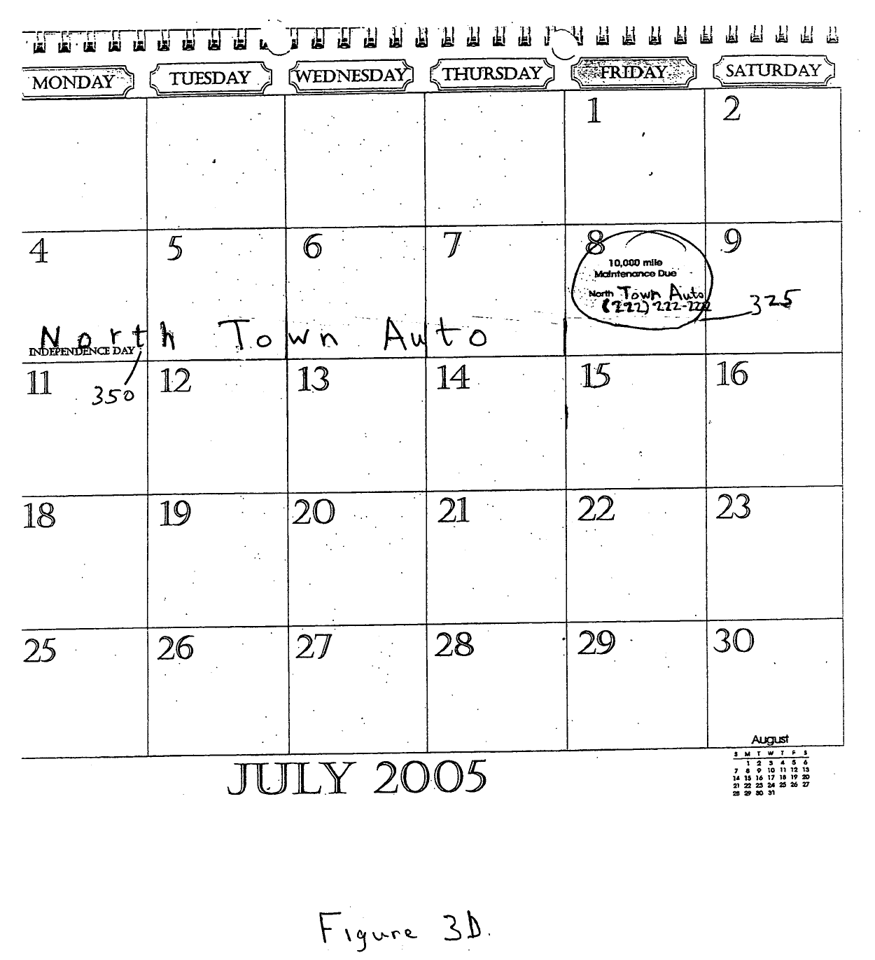

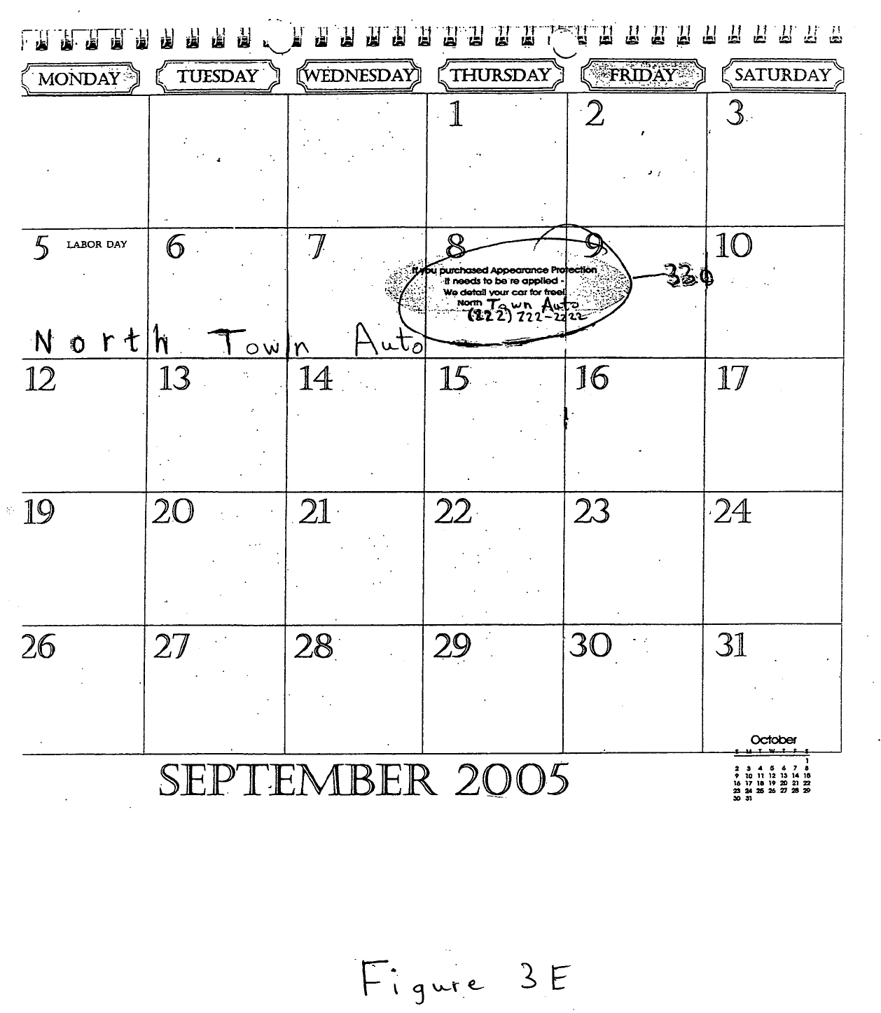

FIGS. 3A to 3E are perspective view of various aspects of scheduling portion 20. Optionally, as shown in FIG. 3A, the date of purchase of the vehicle 305 may also be noted on the scheduling portion of the calendar. The exact date upon which a recommended vehicle maintenance service is to be performed may be determined by any method known to one of skill in the art. Some examples of variables to be considered for determination of recommended vehicle maintenance service dates include, but are not limited to: date of purchase 305, make and model, mileage, engine type, optional accessories (e.g. GPS, filtration, coatings, tires) 330 as shown in FIG. 3E, seller and/or vehicle dealer recommendations 315 FIG. 3B, manufacturer recommendations 320 and 325 FIGS. 3C and 3D, driving conditions, or use of vehicle. In some embodiments of the invention, the anniversary date of vehicle purchase, birthday of vehicle owner, holidays such as Patriot Day 310 as shown in FIG. 3A, Labor Day, Valentine's Day 340 FIG. 3C, Independence Day 350 as shown in FIG. 3D may be displayed in the scheduling portion 20.

Furthermore, recommended vehicle maintenance and service may include, but is not limited to: general vehicle inspection; 30 day vehicle inspection 315 as shown in FIG. 3B; 5,000 mile inspection; 5,000 mile maintenance 320 as shown in FIG. 3C; 10,000 mile maintenance 325 as shown in FIG. 3D; reapplication of appearance protection at the one year anniversary date of the purchase of the vehicle as shown in 330 of FIG. 3E; updating of software for GPS; replacement of tires or batteries at 50,000 miles; replacement of timing belt at 60,000 miles; complimentary vehicle services (ex: exterior cleaning) on the birthday of the vehicle purchaser; complimentary vehicle services (ex: exterior cleaning) on an anniversary date of the purchase of a vehicle; or changing of fluids or tires based on the season (ex: summer versus winter). Variations, permutations, and combinations on such aspects of the embodiments of the invention are also intended to be within the spirit and scope of the invention as claimed below.

Recommended vehicle maintenance and service for a specific vehicle and owner may be determined using hand calculation by a dealer service representative based on the variables and suggestions described above and printed on the calendar using the techniques described in detail below. In some other embodiments of the invention, recommended vehicle maintenance and service may be determined by using a computer that executes a software program. The software program incorporates the variables, suggestions and guidelines for vehicle maintenance and service described above to determine the appropriate dates and mileage for vehicle service that may then be printed on the calendar.

In some embodiments of the invention, information present in personalization portion 10 and scheduling portion 20 that is the same for all vehicles and owners (e.g. name and address of the dealership, day of week, day of month, and calendar structure with box for each day and one month on a page, holidays such as Patriots Day 310, and so on) may be printed on the vehicle maintenance calendar in a printing establishment and sent to the vehicle dealer. To customize the calendar for a specific vehicle and owner, customization information such as a pictorial representation of the vehicle 12, owner 11, date of vehicle purchase 200, type of vehicle purchased 25, personalized message 31 and other customization information shown in FIG. 2 may be printed onto the calendar using high quality printing tools and techniques at the dealership before the owner arrives to pick up the vehicle from the dealership. The printing techniques and tools also allow scheduling portion 20 to be customized for the specific vehicle and owner and, as shown in FIGS. 3A-3E, include date of purchase 305, anniversary information 330 and recommended vehicle maintenance and service 315, 320, 325. Customization in scheduling portion 20 may be printed onto the calendar using high quality printing tools at the dealership before the owner arrives to pick up the vehicle.

In some embodiments of the invention, customization information for a specific vehicle and owner may be placed on the calendar via detachable labels that are printed at a printing establishment and sent to the dealer. Alternatively, in some other embodiments the detachable labels may be printed at the dealership using high quality printing tools and techniques. The detachable labels are attached to the personalization portion 10 and scheduling portion 20 of the vehicle maintenance calendar using an adhesive or other attachment techniques by the dealer.

In accordance with some other embodiments of the invention, information present in the personalization portion and the scheduling portion that is the same for all vehicles and owners and customization information as described above may be printed on the calendar using high quality printing tools and techniques at the dealership before the owner arrives to pick up the vehicle. Such an “on-demand” vehicle maintenance calendar unique for each owner and vehicle provides the highest level of customization and allows for last minutes changes and selections to the vehicle by the owner to be shown in the calendar.

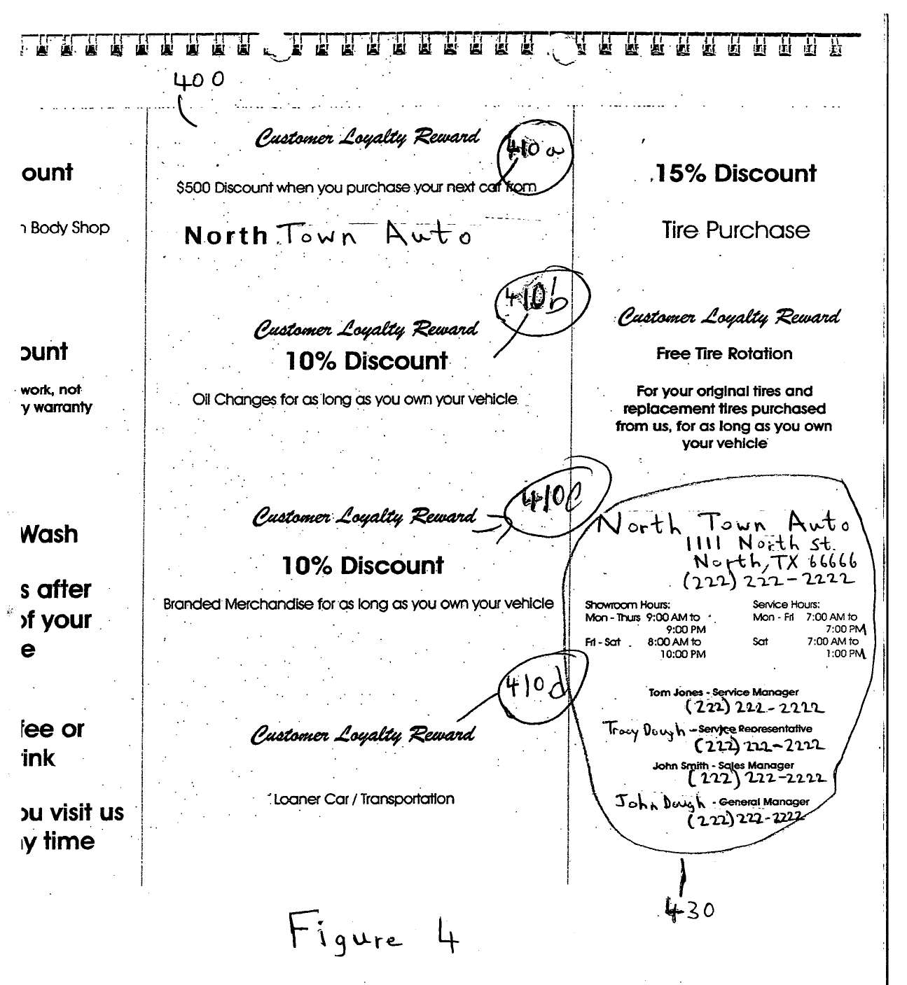

Referring now to FIG. 4, an enlarged view of a coupon appendix 400 in accordance with some embodiments of the invention is shown. The coupon appendix includes various discount coupons 410a-410d for vehicle maintenance and services and vehicle dealership contact information 430. As shown, coupon appendix information 400 may contain some of the same information 13-16 displayed in personalization portion 10. Thus, dealership contact information may be featured in both coupon appendix 400 and personalization portion 10. Similarly, it is contemplated that any of the personalization information may be duplicated within scheduling portion 20 as shown in FIGS. 3A-3E. Such variations are intended to be within the spirit and scope of the embodiments of the invention as claimed below.

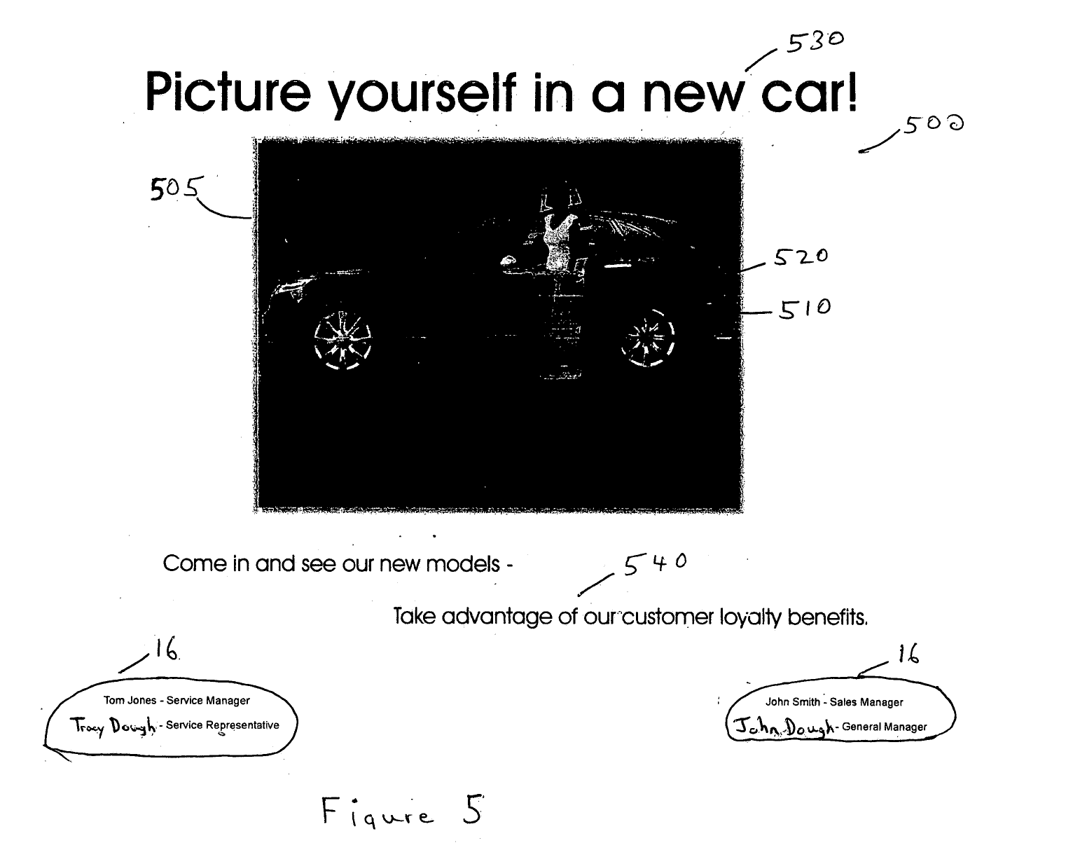

Turning now to FIG. 5, an enlarged view of a customer inducement appendix 500 in accordance with some embodiments of the invention is shown. Pictorial representation 505 shows the vehicle owner in front of a new vehicle that is available at the dealership. Vehicle owner 510 is superimposed and pictured in front of new vehicle 520. In some embodiments of the invention, combining the picture of the owner and vehicle may be performed by scanning, digitizing, and manipulating the pictures. In some other embodiments of the invention, the pictures may be digital images that may be combined and manipulated by digital imaging computer software.

Inducement messages “Picture yourself in a new car!” 530 and “Come in and see our new models-Take advantage of our customer loyalty benefits.” 540 shown in FIG. 5 persuade the owner to purchase another vehicle from the dealership. Personalization information as described above including contact persons 16 and name, contact information, and phone number of the dealership are also shown in the customer inducement appendix 500.

In accordance with some embodiments of the invention, coupon appendix 400 and customer inducement appendix 500 may be located at the end of the calendar for visibility and to allow the owner convenient access. Placement of the customer inducement appendix 500 at the end of the calendar reminds the user after owning the vehicle between 12 to 24 months (depending on the number of months present in the calendar) that a new vehicle is available for them to buy at the dealer.

While the present invention has been described with respect to a limited number of embodiments, those skilled in the art will appreciate numerous modifications and variations therefrom. It is intended that the appended claims cover all such modifications and variations as fall within the true spirit and scope of the embodiments of the present invention.

What is claimed is:

1. A calendar, comprising:
a personalization portion; and
a scheduling portion attached to the personalization portion, wherein said scheduling portion has at least one recommended vehicle maintenance service printed on a particular date.

2. The calendar of claim 1, wherein said personalization portion further comprises:
a photograph;
date of purchase of a vehicle attached to the photograph;
type of the vehicle purchased attached to the photograph;
name of a seller of the vehicle attached to the photograph; and
contact information for the seller of the vehicle attached to the photograph.

3. The calendar of claim 2, wherein the photograph includes the vehicle, an owner of the vehicle, and an environment.

4. The calendar of claim 1, comprising a coupon appendix attached to the personalization portion.

5. The calendar of claim 4, wherein the coupon appendix includes one or more discount coupons for vehicle maintenance services and vehicle dealership contact information.

6. The calendar of claim 1, comprising a customer inducement appendix attached to the personalization portion.

7. The calendar of claim 6, wherein the customer inducement appendix further comprises a picture, wherein the picture includes a vehicle owner and a vehicle.

8. The calendar of claim 7, wherein the vehicle owner is superimposed with the vehicle.

9. A calendar, comprising:
a personalization portion;
a scheduling portion, wherein said scheduling portion has at least one recommended vehicle maintenance service printed on a particular date; and
means for securing said personalization portion to said scheduling portion.

10. The calendar of claim 9, wherein said personalization portion further comprises:
a photograph;
date of purchase of a vehicle attached to the photograph;
type of the vehicle purchased attached to the photograph;
name of a seller of the vehicle attached to the photograph; and
contact information for the seller of the vehicle attached to the photograph.

11. The calendar of claim 9, comprising a customer inducement appendix attached to the personalization portion.

12. The calendar of claim 11, wherein the customer inducement appendix further comprises a picture, wherein the picture includes a vehicle owner and a vehicle.

13. The calendar of claim 12, wherein the vehicle owner is superimposed with the vehicle.

14. A vehicle maintenance scheduling system, comprising:
a calendar; and
at least one recommended maintenance service date printed on said calendar.

15. The vehicle maintenance scheduling system of claim 14, wherein the calendar further comprises a personalization portion.

16. The vehicle maintenance scheduling system of claim 15, wherein said personalization portion further comprises:
a photograph;
date of purchase of a vehicle attached to the photograph;
type of the vehicle purchased attached to the photograph;
name of a seller of the vehicle attached to the photograph; and
contact information for the seller of the vehicle attached to the photograph.

17. The vehicle maintenance scheduling system of claim 14, wherein the calendar further comprises a scheduling portion, wherein said scheduling portion has the at least one recommended maintenance service date.

18. The vehicle maintenance scheduling system of claim 14, wherein the calendar further comprises a customer inducement appendix.

19. The vehicle maintenance scheduling system of claim 18, wherein the customer inducement appendix further comprises a picture, wherein the picture includes a vehicle owner and a vehicle.

20. The vehicle maintenance scheduling system of claim 19, wherein the vehicle owner is superimposed with the vehicle.
